(19) United States
(12) Patent Application Publication
(10) Pub. No.: US 2010/0070361 A1
(43) Pub. Date: Mar. 18, 2010

(54) Network-Based Credit System

(76) Inventors: Timothy Stephen Hurley, Los Gatos, CA (US); Shahid Ahmed, Los Altos, CA (US); Shruti Chugh, San Jose, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 12/210,124

(22) Filed: Sep. 12, 2008

(51) Int. Cl. G06Q 30/00; G06Q 20/00

(52) U.S. Cl. 705/14.23

(57) ABSTRACT

An online credit system is disclosed. The online credit system allows purchasers (requesters) to request and receive credit (e.g., store credit) for prior purchases of qualifying products. The credit can made available to purchasers as an electronic credit voucher. Through online interaction with the online credit system, a purchaser is able to be informed in near real-time whether a particular prior purchase qualifies for an offered credit. The online credit system can also enforce credit eligibility rules so that only certain prior purchases of certain products are able to receive a credit. The online credit system can also incorporate techniques to mitigate or prevent fraudulent attempts to access such credit. In one embodiment, the products qualifying for credit are wireless electronic devices, such as mobile telephones.

### BACKGROUND OF THE INVENTION

1. Field of the Invention

The present invention relates to credits for purchases and, more particularly, to processing customer-initiated credit requests for qualified prior purchases.

2. Description of the Related Art

Store credit has traditionally been available to consumers in-store. As one example, store credit might be provided to a consumer who returns previously purchase items. As another example, store credit might be provided to a consumer that returns to a retail store with a purchase receipt to obtain a credit due because a recently purchased item is now on-sale. As still another example, store credit might be given as a promotion or incentive to shop at a store. The store credit is typically provided to consumers with a card (e.g., gift card), a coupon or a credit receipt.

Unfortunately, however, the conventional store credit solutions typically require consumers to return to the store and request the credit. Requiring that consumers physically return to the store is not only overly burdensome to purchasers but also requires decentralized handling at numerous store locations. Moreover, due to decentralization and substantially manual design, conventional credit processing systems are susceptible to errors and inconsistent results.

Thus, there is a need for improved approaches to processing credit requests.

### SUMMARY OF THE INVENTION

The invention pertains to an online credit system. The online credit system allows purchasers (requesters) to request and receive credit (e.g., store credit) for prior purchases of qualifying products. The credit can made available to the purchasers as an electronic credit voucher. Through online interaction with the online credit system, a purchaser is able to be informed in near real-time whether a particular prior purchase qualifies for an offered credit. The online credit system can also enforce credit eligibility rules so that only certain prior purchases of certain products are able to receive a credit. The online credit system can also incorporate techniques to mitigate or prevent fraudulent attempts to access such credit. In one embodiment, the products qualifying for credit are wireless electronic devices, such as mobile telephones.

The invention can be implemented in numerous ways, including as a method, system, device, apparatus (including computer readable medium or graphical user interface). Several embodiments of the invention are discussed below.

As a computer-implemented method for providing credit to purchasers of wireless electronic devices, one embodiment of the invention can, for example, include at least: presenting credit offer information; receiving a credit request from a requester, the credit request including at least one unique number associated with a particular wireless electronic device, the unique number being provided by the requester; determining whether the particular wireless electronic device is eligible for a credit based on the at least one unique number provided by the requester; sending an electronic notification including a sent access code to the particular wireless electronic device if it is determined that the particular wireless device is eligible for the credit; subsequently receiving an entered access code entered by the requester; determining whether the entered access code matches the sent access code; and providing credit redemption information to the requester if it is determined that the entered access code matches the sent access code.

As a method for providing a credit to a user, one embodiment of the invention can, for example, include at least: presenting a first web page offering a store credit to owners of qualifying wireless communication devices; receiving, from the user, a phone number and a first entered serial number for a particular wireless communication device in possession of the user; determining whether the particular wireless communication device is eligible for the offered store credit based on the phone number and the first entered serial number; sending a SMS message to the particular wireless communication device if said determining determines that the particular wireless communication device is eligible for the offered store credit, the SMS message including an access code; presenting a second web page requesting entry of at least an access code and a serial number for the particular wireless communication device in possession of the user if said determining determines that the particular wireless communication device is eligible for the offered store credit; receiving, from the user, an entered access code and a second entered serial number; determining whether the entered access code and the second entered serial number respectively match the sent access code and the first entered serial number; and presenting a credit voucher web page providing credit redemption information enabling the user to receive the offered store credit if said determining determines that the entered access code and the second entered serial number respectively match the sent access code and the first entered serial number.

As an online credit processing system, one embodiment of the invention can, for example, include at least: a web interface configured to permit a purchaser to identify a previously purchased wireless communication product and request a credit; a transaction database configured to store sales transaction data for wireless communication products; a product activation database configured to store activation data for wireless communication products; and a credit management system operatively connected to said transaction database, said activation database and said web interface. The credit management system being configured to process the request for a credit or payment. The credit management system retrieves corresponding sales transaction data for the prior purchase transaction and thereafter processes the request for credit payment in accordance with predetermined credit eligibility rules and the retrieved sales transaction data to determine whether the request for credit is approved.

As a computer readable storage medium including at least executable computer program code tangibly stored thereon for providing credit to owners of wireless electronic devices, one embodiment of the invention can, for example, include at least: computer program code for presenting credit offer information; receiving a credit request from a requester, the credit request including at least one unique number associated with a particular wireless electronic device, the unique number being provided by the requester; computer program code for determining whether the particular wireless electronic device is eligible for a credit based on the at least one unique number provided by the requester; computer program code for sending an electronic notification including a sent access code to the particular wireless electronic device if it is determined that the particular wireless device is eligible for the credit; computer program code for subsequently receiving an entered access code entered by the requester; computer program code for determining whether the entered access code matches the sent access code; and computer program code for providing credit redemption information to the requester if it is determined that the entered access code matches the sent access code.

Other aspects and embodiments of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, in which:

FIG. 1 is a block diagram of a credit system according to one embodiment of the invention.

FIGS. 2A and 2B are flow diagrams of a credit delivery process according to one embodiment of the invention.

FIG. 3 is a flow diagram of a credit eligibility process according to one environment of the invention.

FIGS. 4A and 4B are flow diagrams of a server-side store credit process according to one embodiment of the invention.

FIG. 5 is a flow diagram of a client-side store credit process according to one embodiment of the invention.

### DETAILED DESCRIPTION OF THE INVENTION

The invention pertains to an online credit system. The online credit system allows purchasers (requesters) to request and receive credit (e.g., store credit) for prior purchases of qualifying products. The credit can made available to the purchasers as an electronic credit voucher. Through online interaction with the online credit system, a purchaser is able to be informed in near real-time whether a particular prior purchase qualifies for an offered credit. The online credit system can also enforce credit eligibility rules so that only certain prior purchases of certain products are able to receive a credit. The online credit system can also incorporate techniques to mitigate or prevent fraudulent attempts to access such credit. In one embodiment, the products qualifying for credit are wireless electronic devices, such as mobile telephones.

In one embodiment, using a web interface, a requester can request credit for a previously purchased wireless communication device, such as a mobile telephone, that is capable of receiving electronic text messages. As part of the credit request processing, if the wireless communication device is eligible for the offered credit, an access code can be sent to the wireless communication device. The requester of the credit can then obtain the access code from the wireless communication device and submit the access code to the online credit system using the web interface, thereby ensuring that the wireless communication device is in the possession of the requester. If the access code is correct, the requester is provided with the credit. The credit can be delivered to the requester as an electronic credit voucher. The electronic credit voucher can, for example, be provided to the requester as a printable web page having a unique alphanumeric character string that can be redeemed online or in-store for access to the credit.

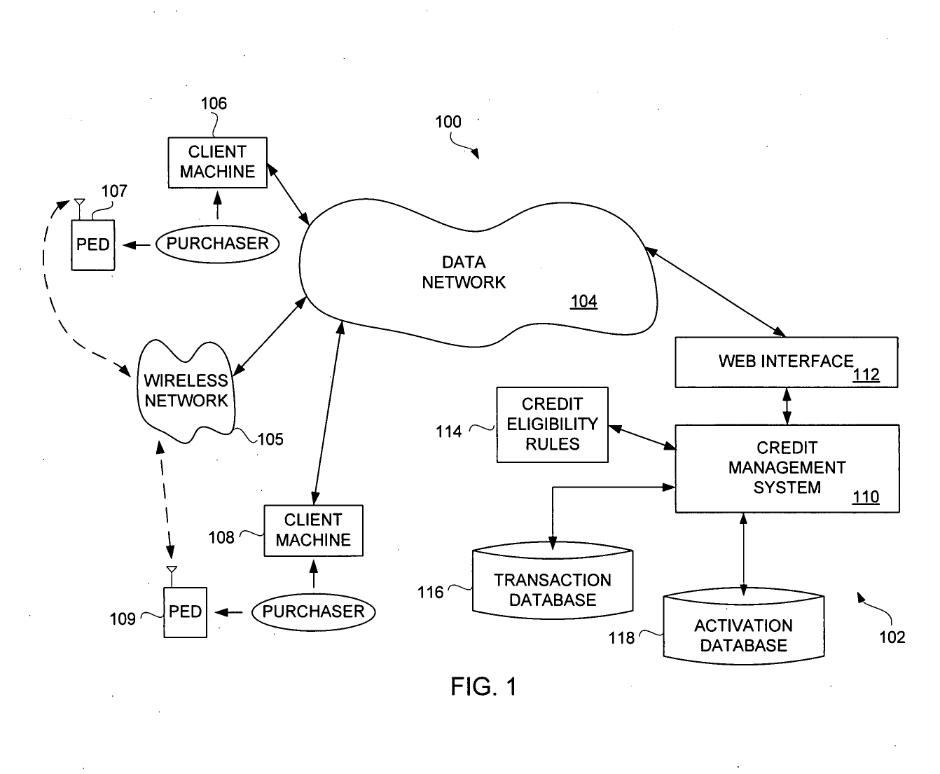

Embodiments of the invention are discussed below with reference to FIGS. 1-5. However, those skilled in the art will readily appreciate that the detailed description given herein with respect to these figures is for explanatory purposes as the invention extends beyond these limited embodiments.

FIG. 1 is a block diagram of a credit system 100 according to one embodiment of the invention. The credit system 100 includes an online credit processing system 102. The credit system 100 also makes use of a data network 104 as well as client machines 106 and 108. The credit system 100 can also made use of a wireless network 105 and portable electronic devices 107 and 109 which can couple to the wireless network 105.

The credit system 100 enables purchasers of one or more qualifying products from a business (e.g., company) to submit a credit request online. For example, a purchaser who has previously purchased one more products can utilize the client machine 106 or 108 to access the online credit processing system 102 via the data network 104 and thereby submit a credit request for a credit. For security reasons, the portable electronic device 107 or 108 associated with the purchaser can also be used to obtain the credit. In some cases, the previously purchased products are the portable electronic devices 107 or 108.

In one embodiment, the data network 104 can represent a global network of interconnected computers, such as the Internet. Advantageously, the purchaser can utilize any client machine with a network browser having access to the data network 104 to submit a credit request to the online credit processing system 102.

The online credit processing system 102 includes a credit management system 110. The credit management system 110 manages the overall processing of credit requests that are submitted to the online credit processing system 102 by purchasers via one or more client machines (e.g., client machines 106, 108). The online credit processing system 102 includes a web interface 112. The web interface 112 is controlled by the credit management system 102 to cause data to be presented to the purchasers at the client machines or to receive data entered by the purchasers at the client machines.

The online credit processing system 102 further includes a transaction database 114 and an activation database 118. The transaction database 114 stores transaction data for purchases that have been made with respect to products that are eligible for a credit. In one embodiment, the products eligible for a credit pertain to certain products of a particular business that were sold during a particular period of time and/or that were sold at a cost greater than a certain price and/or that were sold at particular channels or retailers. For example, a business might sell its products in retail stores (e.g., brick-and-mortar stores) or in online stores, and transaction data for such sales can be stored as transaction data in the transaction database 114. Typically, the particular business offers a credit for the purchase of certain products or combination of products during certain time periods by way of the credit system 100.

Since in one embodiment the portable electronic devices 107 and 109 are typically communication devices, such as mobile telephones, wireless carriers can support voice and data transfer with respect to such devices. For example, the wireless communication devices have associated telephone number that are assigned when wireless service is made available to the devices. The activation database 118 can store activation data for a plurality of wireless communication devices. Among other things, the activation data can associate a serial numbers with corresponding telephone numbers for a plurality of wireless communication devices.

The online credit processing system 102 can also include credit eligibility rules 116. The credit eligibility rules 116 are rules that can be configured so as to control the characteristics of those purchases that are eligible for credits. For example, the credit eligibility rules 116 can take into consideration: (i) date of purchase, (ii) particular one or more products being purchased (e.g., by product types, models or specific serial numbers), and/or (iii) manner in which the one or more products are purchased.

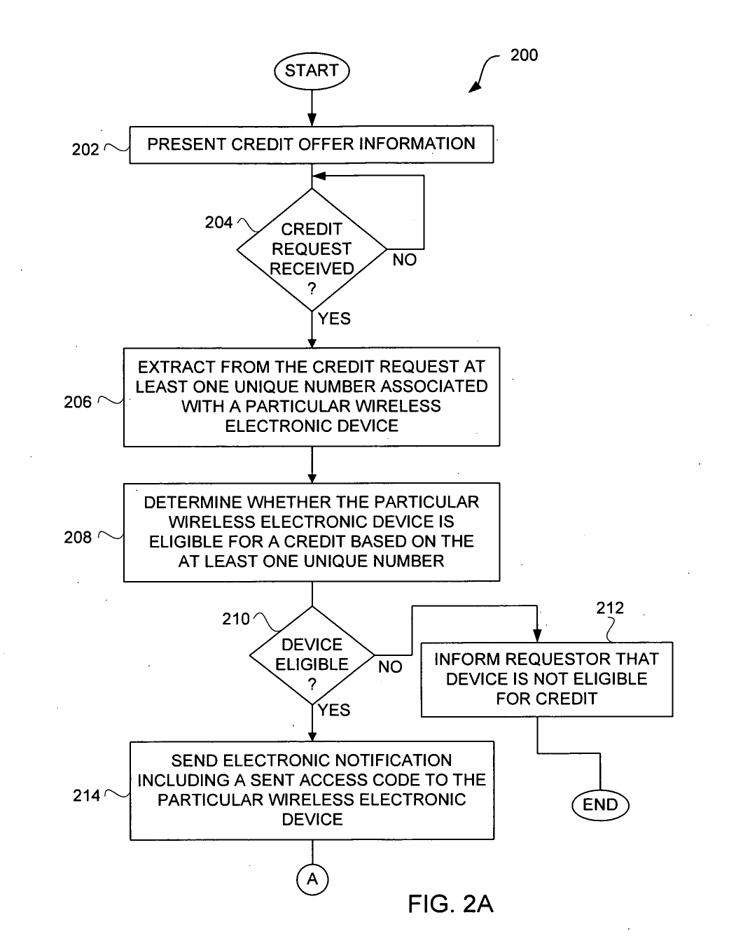

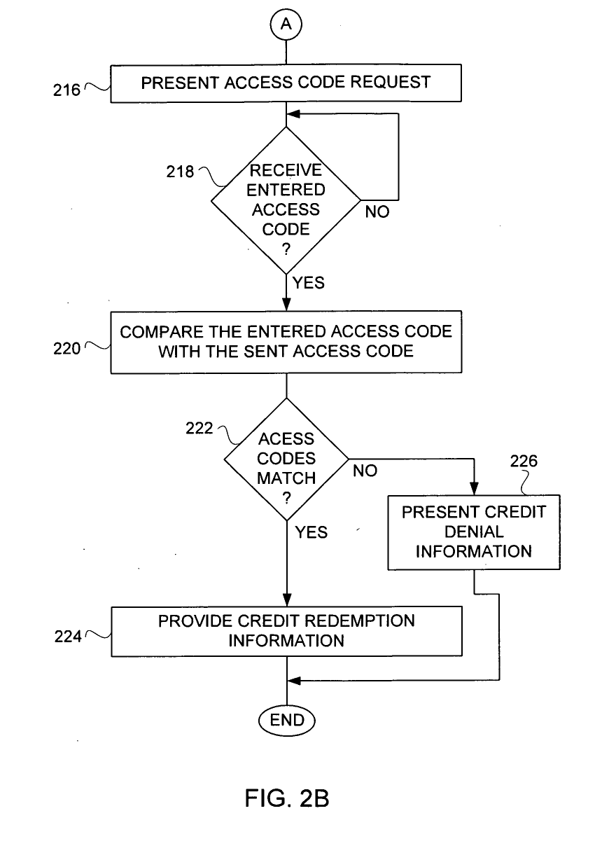

FIGS. 2A and 2B are flow diagrams of a credit delivery process 200 according to one embodiment of the invention. The credit delivery process 200 can, for example, be performed by the online credit processing system 102 Illustrated in FIG. 1.

The credit delivery process 200 can present 202 credit offer information. In one embodiment, the credit offer information is presented in a web page that is accessed by a requester seeking a credit for a product, such as a wireless communication device, previously purchased by the requester. The credit offer information can provide a description of the credit offer, including terms and conditions of the credit offer. The credit offer might be restricted to particular time periods, particular types or models of products (e.g., devices), particular serial numbers, particular sales channels, etc.

After the credit offer information is presented 202, a decision 204 can determine whether a credit request has been received. Here, a credit request is a specific request by a requestor for the credit being offered. The credit being requested is a credit according to the credit offer for the requester prior purchase of a qualifying product. As discussed further herein, the qualifying product for which a credit is sought is a wireless electronic device with messaging capabilities. When the decision 204 determines that a credit request has not yet been requested, the credit delivery process 200 can await such a request.

On the other hand, when the decision 204 determines that a credit request has been received, at least one unique number associated with a particular wireless electronic device is extracted 206 from the credit request. Here, in making the credit request, the requester can be required to provide the at least one unique number that serves as identification information with respect to the particular wireless electronic device. The at least one unique number can, for example, pertain to a serial number, a phone number, or other alphanumeric string.

Next, the credit delivery process 200 can determine 208 whether the particular wireless electronic device is eligible for a credit based on the at least one unique number. A decision 210 can then determine whether the particular wireless electronic device associated with the at least one unique number is determined 208 to be eligible for a credit. When the decision 210 determines that the particular wireless electronic device is not eligible for a credit, the requestor can be informed 212 that the particular wireless electronic device is not eligible for a credit. Optionally, the requestor can be informed 212 of a particular reason why the particular wireless electronic device is not eligible for a credit. Following the block 212, the credit delivery process 200 can end.

Alternatively, when the decision 210 determines that the particular wireless electronic device is eligible for a credit, an electronic notification can be sent 214 to the requester and via the particular wireless electronic device. The electronic notification can, for example, include a sent access code. As an example, the electronic notification can be sent to the particular wireless electronic device has a short text message, such as a SMS message.

Next, an access code request can be presented 216. As an example, the access code request can be presented 216 to the requester as an access code web page that at least requests that the requestor enter an access code. A decision 218 can then determine whether an entered access code has been received in response to the access code request. When the decision 218 determines that an entered access code has not yet been received, the credit delivery process 200 can await the receipt of the requested access code.

On the other hand, when the decision 218 determines that the entered access code has been received, the entered access code can be compared 220 with the sent access code. Next, a decision 222 can determine whether the access codes match. In particular, the decision 222 can determine whether the entered access code matches the previously sent access code. When the decision 222 determines that the access codes do not match, credit denial information can be presented 226 to the requester. Alternatively, when the decision 222 determines that the access codes do match, credit redemption information can be provided 224 to the requester. In one embodiment, the credit redemption information can be provided as an electronic credit voucher. One example of an electronic credit voucher is an electronic card containing a unique identification code and a PIN code. Following the blocks 224 and 226, the credit delivery process 200 can end.

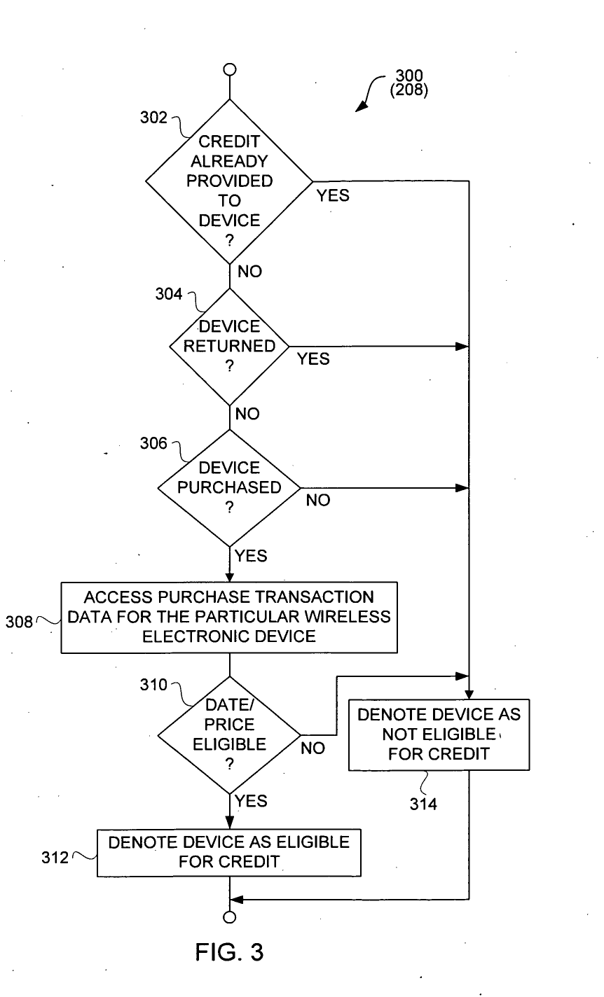

FIG. 3 is a flow diagram of a credit eligibility process 300 according to one environment of the invention. The credit availability process 300 can, for example, represent processing performed by the block 208 illustrated in FIG. 2A.

The credit eligibility process 300 can begin with a decision 302 that determines whether a credit has already been provided to the particular wireless electronic device. When the decision 302 determines that the particular wireless electronic device has not previously been used to obtain a credit, a decision 304 determines whether the particular wireless electronic device has been returned. When the decision 304 determines that the particular wireless electronic device has not been returned, a decision 306 can determine whether the particular wireless electronic device was purchased. For example, the particular wireless electronic device could be a loaned device or a promotional device and thus not have previously purchased the device, thereby making the device not entitled to the credit.

In any case, when the decision 306 determines that the particular wireless electronic device was purchased, not returned and not previously used to obtain a credit, then purchase transaction data for the particular wireless electronic device can be accessed 308. Then, a decision 310 determines whether the particular wireless electronic device is date and/or price eligible. Here, eligibility rules can limit availability of the credit offer to certain transaction time periods or transaction prices. The decision 310 can use the eligibility rules and the transaction data to determine whether the particular wireless electronic device is date and/or price eligible to received the credit. When the decision 310 determines that the particular wireless electronic device is date and/or price eligible, the particular wireless electronic device is denoted 312 as eligible for the credit. Alternatively, when the decision 310 determines that the particular wireless electronic device it is not eligible due to data and/or price restrictions, then the particular wireless electronic device is denoted 314 as not eligible for the credit. In addition, when the decision 302 determines that the particular wireless electronic device has already been allocated a credit, when the decision 304 determines that the particular wireless electronic device has been returned, or when the decision 306 determines that the particular wireless electronic device was not purchased, the particular wireless electronic device can also be denoted 314 as not eligible for the credit. Following the block 312 or the block 314, the credit eligibility process 300 can end.

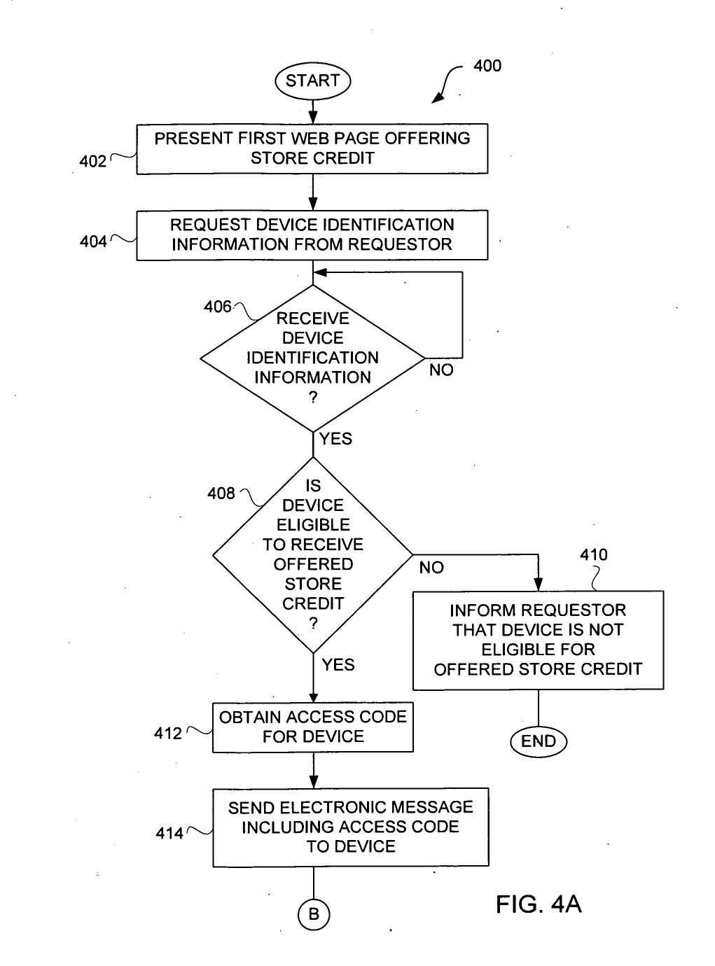

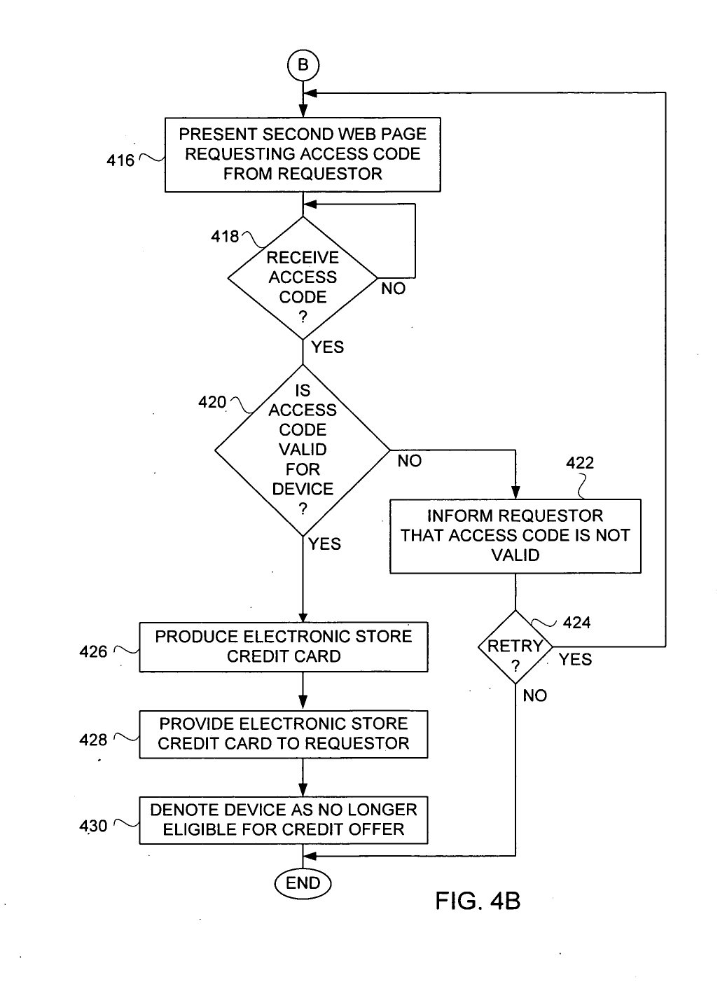

FIGS. 4A and 4B are flow diagrams of a server-side store credit process 400 according to one embodiment of the invention. The server-side store credit process 400 can, for example, be performed by a server computing system, such as the online credit processing system 102 illustrated in FIG. 1.

The server-side store credit process 400 can present 402 a first web page offering a store credit. In addition, device identification information can be requested 404 from a requester that seeks a credit for a product, namely, a wireless communication device. The device identification information can be requested 404 with the first web page or a subsequent web page. A decision 406 can then determine whether device identification information has been received. When the decision 406 determines that device identification information has not yet been received, the server-side store credit process 400 can await such information.

Alternatively, when the decision 406 determines that device identification information has been received, a decision 408 can determine whether the device is eligible to receive the offered store credit. Here, eligibility rules, transaction data and/or activation data can be accessed in order to decide whether the device is eligible to receive the offered store credit. When the decision 408 determines that the device is not eligible to receive the offered store credit, the requester can be informed 410 that the device is not eligible for the offered store credit. Following the block 410, the server-side store credit process 400 can end.

On the other hand, when the decision 408 determines that the device is eligible to receive the offered store credit, an access code for the device can be obtained 412. The access code for the device can be generated as needed or can be retrieved from a data storage device that stores a plurality of access codes in advance. After the access code is obtained, an electronic message including the access code can be sent 414 to the device. For example, a text message including the access code can be sent to the device. A second webpage can also be presented 416 to the requester. The second webpage can request an access code be entered by the requester. Here, the requester can interact with the second webpage to enter an access code (that was sent 414 to the device). A decision 418 can then determine whether an access code has been received from the requester. When the decision 418 determines that an access code has not been received, the server-side store credit process 400 can await receipt of an access code.

Once the decision 418 determines that an access code has been received, a decision 420 can determine whether the access code is valid for the device. In other words, the access code being entered by the requester should match the access code that was previously sent to the device itself by way of the electronic message at block 414. When the decision 420 determines that the entered access code is not valid for the device, the requester can be informed 422 that the access code is not valid. A decision 424 can then determine whether the requester is permitted to retry entry of an access code. When the decision 424 determines that the requester is permitted to retry entry of an access code, the server-side store credit process 400 can return to repeat the block 416 and subsequent blocks so that the requester can again enter an access code. On the other hand, when the decision 424 determines that the requestor is not permitted to retry entry of an access code, and the server-side store credit process 400 can end.

Alternately, when the decision 420 determines that the entered access code is valid for the device, an electronic store credit card can be produced 426. The electronic store credit card is a virtual card having at least one unique identifier. Typically, the unique identifier is an alphanumeric string. The electronic store credit card can then be provided 428 to the requester. In one embodiment, the virtual card can be presented to the user with a web page. In another embodiment, the virtual card can be electronically transmitted (e.g., via e-mail or text message) to the requester. Thereafter, the device for which the credit is being made available to the requester by the electronic store credit card is denoted 430 as no longer eligible for the credit offer. Here, since the offered credit has been made available to the requester due to the prior purchase of the particular electronic device, the particular electronic device is no longer eligible to receive the offered credit again. Following the block 430, the server-side store credit process 400 can end.

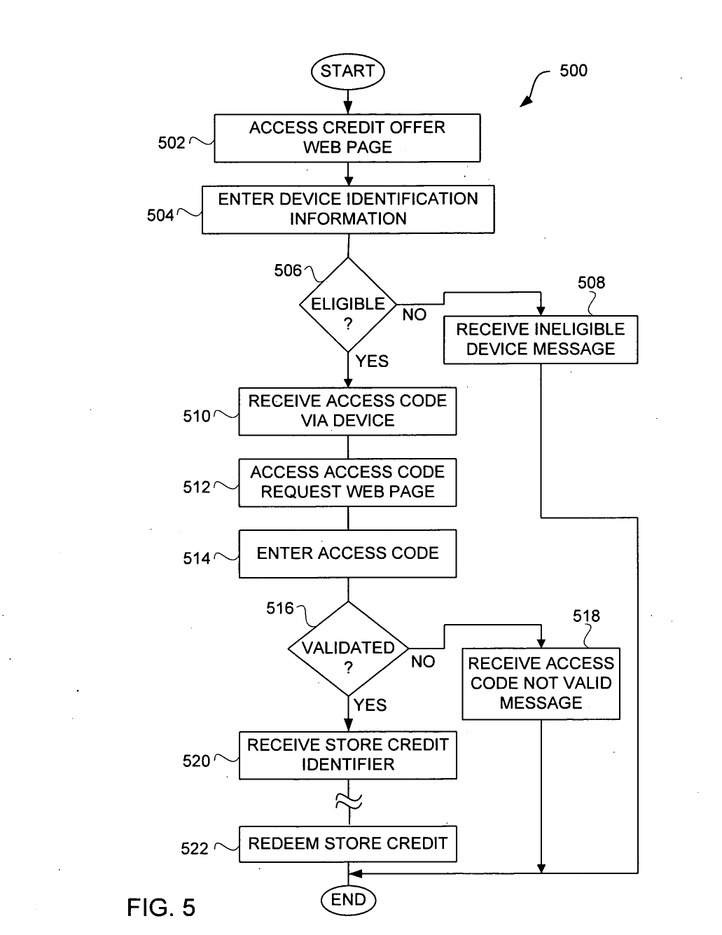

FIG. 5 is a flow diagram of a client-side store credit process 500 according to one embodiment of the invention. In general, the client-side store credit process 500 represents counterpart processing that can be utilized at a client computing system and that interacts via a network with a server computing system performing server-side processing, such as the server-side store credit process 400 illustrated in FIGS. 4A and 4B.

The client-side store credit process 500 enables a requester to access 502 a credit offer webpage. The credit offer webpage offers visitors (users) the opportunity to request a credit due to a prior purchase of an eligible product, such as a wireless communication device. When a requester (user) desires to submit a request for credit, the requestor can enter 504 device identification information. The device identification information serves to identify the prior product that was purchased. For example, the device identification information can pertain to a serial number and/or a telephone number. In one embodiment, a credit offer web page includes information descriptive of the credit offer as well as one or more text entry boxes that facilitate the entry of the device identification information. In one example, a serial number and a telephone number for the device for which the requester is requesting a credit can be entered into the text entry boxes of the credit offer page. A decision 506 can then determine whether the device identification information indicates eligibility of the device. Here, the server computing system can process the device identification information to determine whether the particular device is eligible for the credit being offered. If it is determined that the particular device is not eligible for a credit, an ineligible device message can be received 508. As one example, the ineligible device message can be provide as part of a web page. Optionally, the ineligible device message can also indicate one or more reasons for its ineligibility. After receiving the ineligible device message, the client-side store credit process 500 can end.

Alternatively, when the decision 506 determines that the particular device is eligible for the credit, an access code can be received 510 via the particular device. Here, the server computing system can cause an electronic message to be sent directly to the particular device. For example, the electronic message can be a SMS message. The electronic message includes an access code that is required for the requester to continue with the credit request process. When the decision 506 determines that the particular device is eligible for the credit, an access code request web page can also be accessed 512. The access code web page can assist the requester with entry 514 of the required access code. The required access code is the access code that was included with the electronic message that was sent to the particular device. A decision 516 can then determine whether the access code has been successfully validated by the server computing system. When the decision 516 determines that the access code was not successfully validated, an access code and not valid message can be received 518 at the client computing system (or the particular device). Following the block 518, the client-side store credit process 500 can end since the requester has not provided in the correct access code.

On the other hand, when the decision 516 determines that the access code has been successfully validated, a store credit identifier can be received 520. The store credit identifier can be provided in the form of an electronic credit card. At this point, the requestor has received the requested credit and can thereafter redeem 522 the credit at either a physical store or an online store. Typically, the requestor enters the credit identifier at the online store or provides the store credit identifier (or a bar code version thereof) to an in-store point of sale representative. Following the block 522, the client-side store credit process 500 can end.

According to another aspect of the invention, eligibility of credits can be determined in a computerized manner in accordance with predetermined eligibility rules. The eligibility rules can implement business rules pertaining to credits. These rules can be constructed to potentially take into consideration one or more factors. Examples of some factors are: date of purchase, submission date, promotion available date, promotion end date, credit limit (e.g., maximum number of credits per purchase transaction), qualifying part numbers, products types (or classes), subclasses, geographic location, retail channel, store type (e.g., online or “brick & mortar”), and particular store. As such, characteristics of credits being offered can be customized using one or more of the factors. In one embodiment, a credit configuration tool can be used by an online credit system to enable a business to configure how, when and for what the business offers credits. The credit configuration tool can present a graphical user interface that enables a user to select appropriate factors and ranges, values or conditions for such factors. The credit configuration tool also permits dynamic changes to the availability and/or characteristics of the credits.

The various aspects, embodiments, implementations or features of the invention can be used separately or in any combination.

The invention is preferably implemented by software, hardware, or a combination of hardware and software. The invention can also be embodied as computer readable code on a computer readable medium (or computer readable storage medium). The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different embodiments or implementations may, but need not, yield one or more of the following advantages. One advantage of certain embodiments of the invention is that credit requests can be submitted online and computerized decisions can provide near real-time approval or denial. Another advantage of certain embodiments of the invention is that credit requests can be processed in a manner to prevent fraudulent requests. Still another advantage of certain embodiments of the invention is that user experience with credit requests that users initiate is dramatically enhanced with an online rebate system.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for providing credit to purchasers of wireless electronic devices, said method comprising:
presenting credit offer information;
receiving a credit request from a requester, the credit request including at least one unique number associated with a particular wireless electronic device, the unique number being provided by the requester;
determining whether the particular wireless electronic device is eligible for a credit based on the at least one unique number provided by the requester;
sending an electronic notification including a sent access code to the particular wireless electronic device if said determining determines that the particular wireless device is eligible for the credit;
subsequently receiving an entered access code entered by the requester;
determining whether the entered access code matches the sent access code; and
providing credit redemption information to the requester if said determining determines that the entered access code matches the sent access code.

2. A computer-implemented method as recited in claim 1, wherein said method further comprises:
providing credit denial information to the requester if said determining determines that the entered access code does not match the sent access code.

3. A computer-implemented method as recited in claim 1, wherein the wireless electronic device is a wireless communication device.

4. A computer-implemented method as recited in claim 3, wherein the at least one unique number includes a telephone number and a serial number of the particular wireless electronic device.

5. A computer-implemented method as recited in claim 3, wherein the wireless electronic device is a mobile telephone with wireless network access and capable of telephone calls, short text messages and network browsing.

6. A computer-implemented method as recited in claim 5, wherein the electronic notification is a short text message.

7. A computer-implemented method as recited in claim 1, wherein the electronic notification is a SMS message.

8. A computer-implemented method as recited in claim 1, wherein the credit redemption information includes at least a unique card number and a PIN.

9. A computer-implemented method as recited in claim 1,
wherein the wireless electronic device is a wireless communication device,
wherein the at least one number provided by the requestor include a serial number of the wireless communication device and a telephone number for the wireless communication device,
wherein said sending comprises sending an SMS message including the sent access code to the telephone number for the wireless communication device, and
wherein said providing an electronic credit voucher to the requester.

10. A method for providing a credit to a user, said method comprising:
presenting a first web page offering a store credit to owners of qualifying wireless communication devices;
receiving, from the user, a phone number and a first entered serial number for a particular wireless communication device in possession of the user;
determining whether the particular wireless communication device is eligible for the offered store credit based on the phone number and the first entered serial number;
sending a SMS message to the particular wireless communication device if said determining determines that the particular wireless communication device is eligible for the offered store credit, the SMS message including an access code;
presenting a second web page requesting entry of at least an access code and a serial number for the particular wireless communication device in possession of the user if said determining determines that the particular wireless communication device is eligible for the offered store credit;
receiving, from the user, an entered access code and a second entered serial number;
determining whether the entered access code and the second entered serial number respectively match the sent access code and the first entered serial number; and
presenting a credit voucher web page providing credit redemption information enabling the user to receive the offered store credit if said determining determines that the entered access code and the second entered serial number respectively match the sent access code and the first entered serial number.

11. A computer-implemented method as recited in claim 10, wherein the store credit is credit redeemable at an online store or at a physical store.

12. A computer-implemented method as recited in claim 10, wherein the credit redemption information includes at least a unique card number associated with the store credit.

13. A computer-implemented method as recited in claim 10, wherein the credit redemption information includes at least a unique card number and a PIN associated with the store credit.

14. A computer-implemented method as recited in claim 10, wherein said method further comprises:
presenting a rejection web page informing the user of rejection of the credit if said determining determines that the particular wireless communication device is not eligible for the offered store credit.

15. A computer-implemented method as recited in claim 10, wherein said method further comprises:
denoting the wireless communication device as no longer eligible for the credit after said presenting of the credit voucher web page with the credit redemption information.

16. An online credit processing system, comprising:
a web interface configured to permit a purchaser to identify a previously purchased wireless communication product and request a credit;
a transaction database configured to store sales transaction data for wireless communication products;
a product activation database configured to store activation data for wireless communication products; and
a credit management system operatively connected to said transaction database, said activation database and said web interface, said credit management system being configured to process the request for a credit or payment, said credit management system retrieving corresponding sales transaction data for the prior purchase transaction and thereafter processing the request for credit payment in accordance with predetermined credit eligibility rules and the retrieved sales transaction data to determine whether the request for credit is approved.

17. An online credit processing system as recited in claim 16, wherein the credit is provided to the requester as a credit voucher.

18. An online credit processing system as recited in claim 16, wherein the wireless communication product is a mobile telephone.

19. An online credit processing system as recited in claim 16, wherein said credit management system checks to see if a credit has already been provided for the prior purchase transaction before approving the request for credit payment.

20. An online credit processing system as recited in claim 19,
wherein said web interface provides a credit offer web page and an access code request web page to the requester, and wherein said web interface provides a credit approval page if the request for credit or payment has been approved.

21. A computer readable storage medium including at least executable computer program code tangibly stored thereon for providing credit to owners of wireless electronic devices, said computer readable storage medium comprising:
computer program code for presenting credit offer information;
receiving a credit request from a requester, the credit request including at least one unique number associated with a particular wireless electronic device, the unique number being provided by the requester;
computer program code for determining whether the particular wireless electronic device is eligible for a credit based on the at least one unique number provided by the requester;
computer program code for sending an electronic notification including a sent access code to the particular wireless electronic device if said determining determines that the particular wireless device is eligible for the credit;
computer program code for subsequently receiving an entered access code entered by the requester;
computer program code for determining whether the entered access code matches the sent access code; and
computer program code for providing credit redemption information to the requester if said determining determines that the entered access code matches the sent access code.
